(19) United States
(12) Patent Application Publication
(10) Pub. No.: US 2006/0226221 A1
(43) Pub. Date: Oct. 12, 2006

(54) System and method for electronic voting

(76) Inventor: Kevin Langberg, Plainview, NY (US)

Correspondence Address: F. CHAU & ASSOCIATES, LLC, 130 WOODBURY ROAD, WOODBURY, NY, 11797, US

(21) Appl. No.: 11/103,752

(22) Filed: Apr. 12, 2005

(51) Int. Cl. G07C 13/00

(52) U.S. Cl. 235/386; 705/12

(57) ABSTRACT

A system and method for electronic voting are provided. The system comprises: a voting device including a processor for processing voting information; a display for displaying the voting information and a voting selection; an input for receiving the voting selection; a printer for printing a ballot having a ballot portion and a receipt portion; and a ballot box for receiving the ballot portion; a privacy screen for impeding unauthorized viewing of the voting device from side perspectives during voting; and a pedestal for performing one of a placing the voting device in a voting configuration and in a transportation configuration.

### BACKGROUND OF THE INVENTION

1. Technical Field

The present invention relates to voting machines, and more particularly, to a system and method for electronic voting.

2. Discussion of the Related Art

Current election processes using paper ballots have been the subject of recent controversy because of questions concerning their accuracy, potential for voter confusion and fraud. For example, when using hand-marked or punch card type paper ballots, the incomplete or partial marking of a box or the incomplete punching out of a chad result in difficulties in determining what is and is not a voted ballot. In addition, voter confusion may arise as detailed instructions are typically not included in a voting machine using paper ballots. Further, when using paper ballots, real ballots may be replaced with fraudulent ballots by an unscrupulous vote counter.

In order to overcome some of the drawbacks of paper ballot voting machines, numerous electronic voting machines have been developed. Some of these voting machines include, for example, voting tablets with printed ballot overlays placed on top by a voter. Others include memory modules created by a computer at the same time a system printer creates a personalized ballot for each voter. These systems, however, typically do not provide a written record of voter intent. In addition, they require multiple devices resulting in a system prone to breakdowns and interruption of voting activity.

In another electronic voting system employing memory modules, a movable memory having internal batteries for maintaining voting results stored on computer readable media is used. In some instances, such systems may be prone to losing voting data as their batteries lose charge. In addition, because these systems require the computer readable media to be transported between polling locations, they suffer from the possibility that the media will be sent to the wrong location. Moreover, these systems are susceptible to fraud and tampering as the media is moved from place to place.

Direct recording electronic voting systems that use an electronic representation of a ballot have also been developed. These systems, however, do not make a marked paper ballot because they rely on software and computer processing as the exclusive method of vote recording. Thus, because marked paper ballots are nonexistent, no ballot is available for auditing should questions arise as to vote count authenticity.

Some electronic voting systems also use a touch screen display. In such systems, voters scroll through options before making voting decisions by touching indicated portions of the screen. These systems, however, can confuse and in some instances frustrate voters causing incorrect or incomplete ballots resulting from such anxiety. Further, the cost of a touch screen display at each voting station makes such systems cost prohibitive.

Accordingly, there is a need for an electronic voting apparatus that is easy to use and re-configure and that provides a redundant system for vote authentication in a tamper resistant and cost-effective manner.

### SUMMARY OF THE INVENTION

The present invention overcomes the foregoing and other problems encountered in the known teachings by providing a system and method for electronic voting.

In one embodiment of the present invention, an electronic voting device comprises: a processor for processing voting information; a display for displaying the voting information and a voting selection; an input for receiving the voting selection; a printer for printing a ballot having a ballot portion and a receipt portion, wherein the ballot portion and the receipt portion comprise the voting selection; and a ballot box for receiving the ballot portion.

The processor comprises a memory for storing the voting information and a voting record associated with the voting selection. The display is one of a cathode ray tube (CRT) display, a liquid crystal display (LCD), and a plasma display. The display is one of a touch-type display and a rotatable display. The input is a keypad. The keypad includes raised keys with Braille.

The printer is one of a modular thermal printer, a dot-matrix printer, and an impact-type printer. The ballot box comprises a tamper-proof ballot receptacle. The device further comprises an external memory interface for receiving updated voting information, an input/output (I/O) interface for performing one of receiving updated voting information and uploading a voting selection to an external device, and a power source. The power source is an internal battery.

The ballot portion of the ballot comprises: a first portion comprising: an election identifier; a ballot identifier; a transaction number; and a bar code identifier; and a second portion comprising: a first listing of the voting selection and an associated bar code identifier, the receipt portion of the ballot comprises: a first portion comprising: the election identifier; the ballot identifier; and the transaction number; and a second portion comprising: a second listing of the voting selection.

In another embodiment of the present invention, an electronic voting system comprises: a voting device comprising: a processor for processing voting information; a display for displaying the voting information and a voting selection; an input for receiving the voting selection; a printer for printing a ballot having a ballot portion and a receipt portion; and a ballot box for receiving the ballot portion; a privacy screen for impeding unauthorized viewing of the voting device from side perspectives during voting; and a pedestal for performing one of placing the voting device in a voting configuration and in a transportation configuration.

The privacy screen is connected along a left and right side and back of the electronic voting device. The pedestal is connected to a bottom of the voting device when in the voting configuration and to a top of the voting device when in a transportation configuration.

In yet another embodiment of the present invention, a ballot comprises: a ballot portion comprising: a first portion comprising: an election identifier; a ballot identifier; a transaction number; and a bar code identifier; and a second portion comprising: a first listing of a voting selection and a bar code identifier associated with the voting selection; and a receipt portion comprising: a first portion comprising: the election identifier; the ballot identifier; and the transaction number; and a second portion comprising: a second listing of the voting selection. The election identifier identifies an election, the ballot identifier identifies an area of the election and an election district number, the transaction number identifies a date of the election and the election district number, and the bar code identifier includes the information of the transaction number.

In another embodiment of the present invention, a method for electronic voting comprises: providing voting instructions; receiving an instruction to proceed with voting; displaying one of a proposition and an office to be voted for; receiving a voting selection in response to one of the proposition and the office to be voted for; providing a review screen comprising the voting selection; determining the voting is complete; and printing a ballot comprising a ballot portion and a receipt portion, wherein the ballot portion and the receipt portion comprise the voting selection. The method further comprises receiving the ballot portion.

The foregoing features are of representative embodiments and are presented to assist in understanding the invention. It should be understood that they are not intended to be considered limitations on the invention as defined by the claims, or limitations on equivalents to the claims. Therefore, this summary of features should not be considered dispositive in determining equivalents. Additional features of the invention will become apparent in the following description, from the drawings and from the claims.

### BRIEF DESCRIPTION OF THE DRAWINGS

FIG. 1 is an electronic voting system according to an exemplary embodiment of the present invention;

FIG. 2 is a perspective view of the electronic voting system of FIG. 1;

FIG. 3 is an alternate configuration of the electronic voting system of FIG. 1;

FIG. 4 is a voting unit of the electronic voting system of FIG. 1;

FIG. 5 is a ballot of the voting unit of FIG. 4;

FIG. 6 is a keypad of the voting unit of FIG. 4;

FIG. 7 is a ballot template of the voting unit of FIG. 4;

FIG. 8 is an exemplary embodiment of a voting unit according to an exemplary embodiment of the present invention;

FIG. 9 is a flowchart illustrating a method for electronic voting according to an exemplary embodiment of the present invention;

FIG. 10 is a screen-shot of a display of the voting unit of FIG. 4;

FIG. 11 is another screen-shot of the display;

FIG. 12 is yet another screen-shot of the display;

FIG. 13 is a screen-shot of the display;

FIG. 14 is another screen-shot of the display;

FIG. 15 is yet another screen-shot of the display; and

FIG. 16 is another screen-shot of the display.

### DETAILED DESCRIPTION OF EXEMPLARY EMBODIMENTS

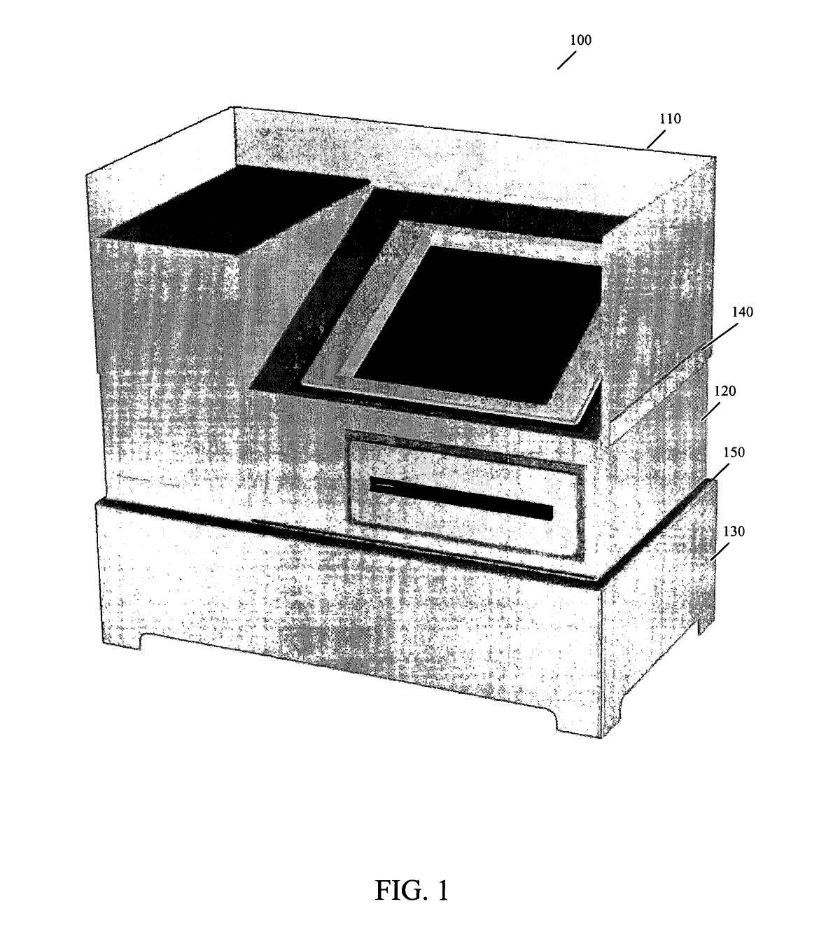

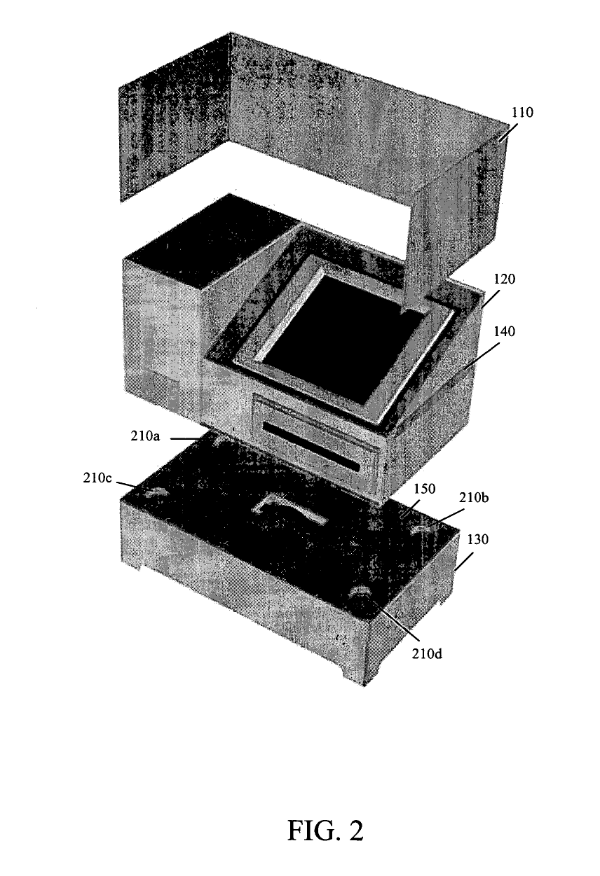

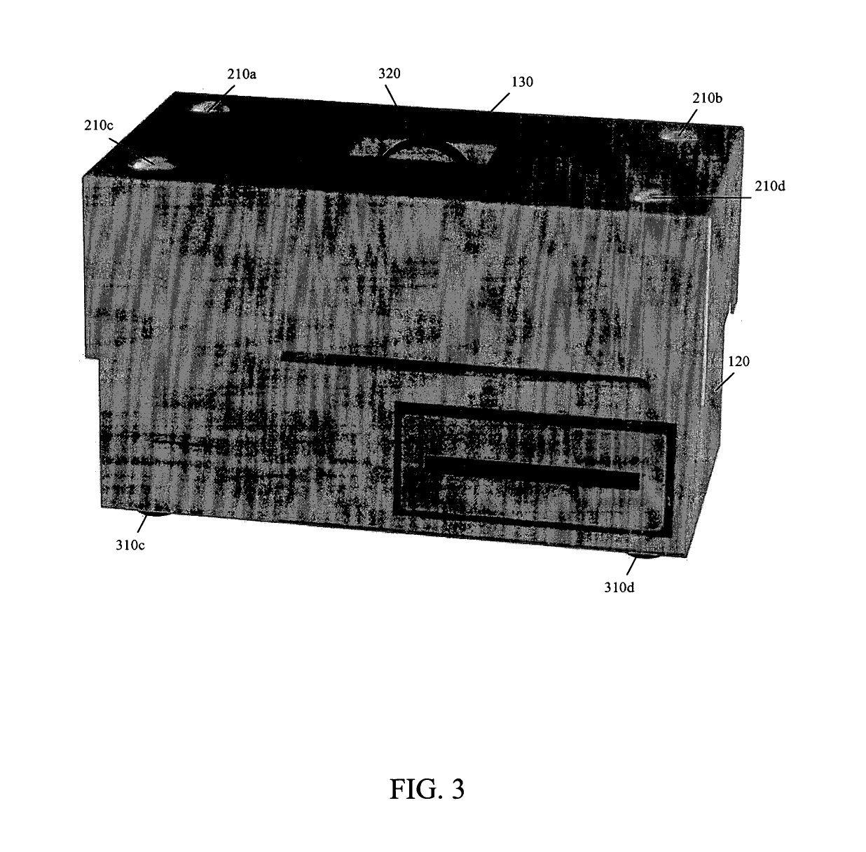

FIG. 1 is an electronic voting system 100 according to an exemplary embodiment of the present invention. As shown in FIG. 1, the electronic voting system 100 includes a privacy screen 110, a voting unit 120 and a pedestal 130. The privacy screen 110 is coupled to the voting unit 120 by a coupling means 140 mounted to the sides and/or rear of the voting unit 120. The voting unit 120 is coupled to a top portion 150 of the pedestal 130. The voting unit 120 may be coupled to the pedestal 130 by inserting a set of male coupling members 310a-d (shown in FIG. 3) of the voting unit 120 into a set of female coupling members 210a-d (shown in FIG. 2) on the top portion 150 of the pedestal 130.

To configure the electronic voting system 100, the privacy screen 110, voting unit 120 and pedestal 130 may be connected together as shown in FIG. 2. The electronic voting system 100 may also be configured so that it may be transported. For example, as shown in FIG. 3, the pedestal 130 may be placed on top of and secured to the voting unit 120 and then transported using a handle 320 of the pedestal 130. As shown in FIG. 3, the electronic voting system 100 may be inserted into a custom carrying case having an opening for allowing the handle 320 to pass thus enabling the electronic voting system 100 to be transported.

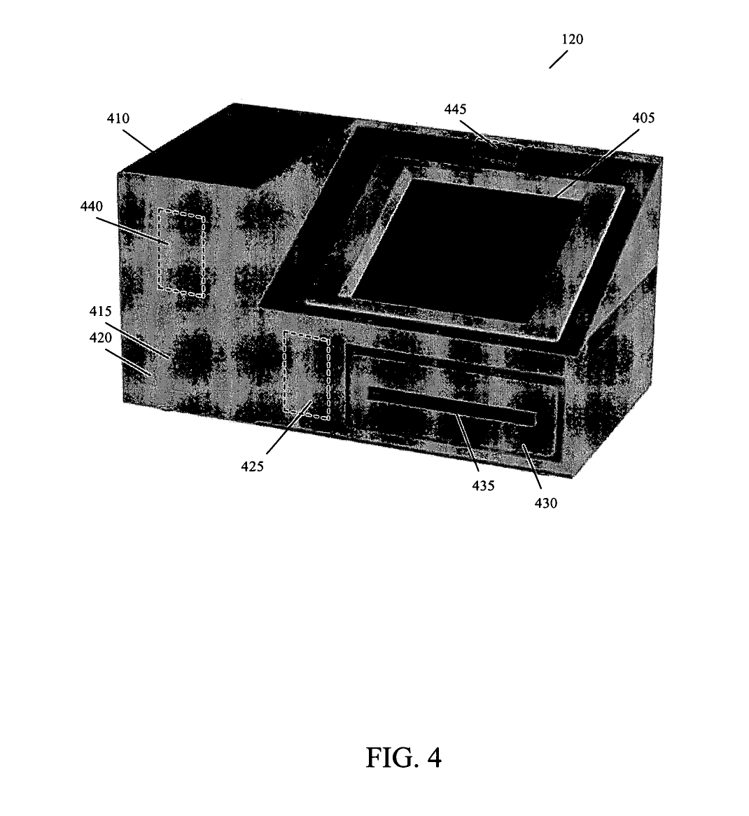

FIG. 4 illustrates the voting unit 120 of FIG. 1 in more detail. As shown in FIG. 4, the voting unit 120 includes a display screen 405, a printer tower 410, a keypad 425, a ballot box 430 and a tamper-resistant ballot receptacle 435. The display screen 405 may be, for example, a cathode ray tube (CRT) display, a liquid crystal display (LCD) or a plasma display and is used to display voting information. The display screen 405 may also be an interactive touch-type display or a tilt-type display to allow for different viewing angles.

The printer tower 410 may include, for example, a modular thermal printer (not shown) or any printer capable of high-speed, high-resolution printing in a kiosk type environment such as a dot matrix or impact type printer. The modular thermal printer is used to print a ballot 420 indicating, for example, a voter's selection of certain candidates. The printer tower 410 further includes a ballot output 415 for outputting the ballot 420.

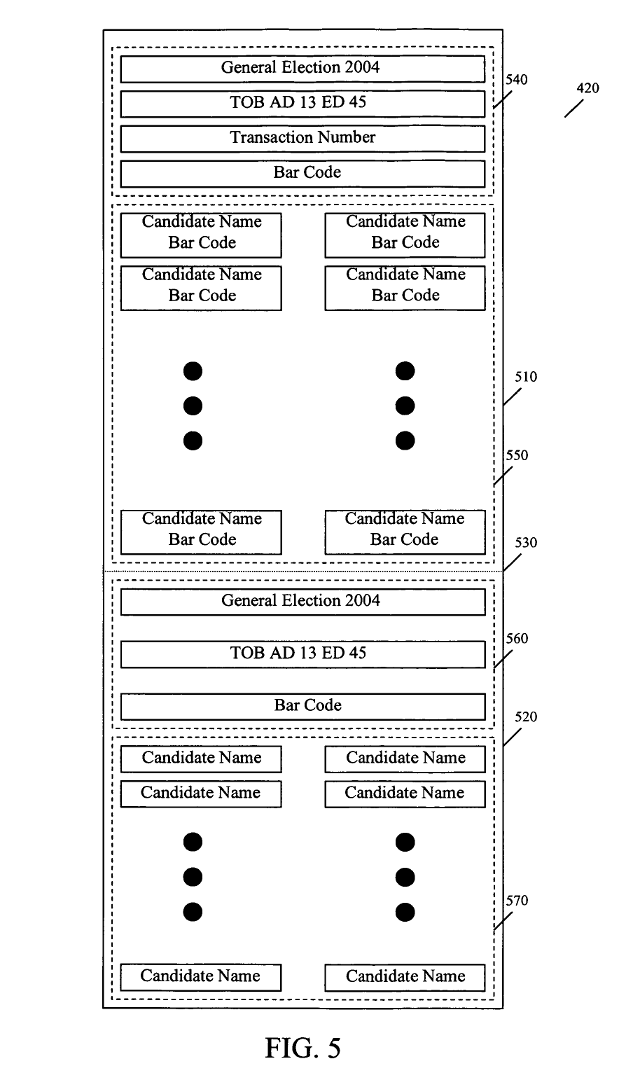

FIG. 5 illustrates an exemplary embodiment of the ballot 420. As shown in FIG. 5, the ballot 420 includes a ballot portion 510 and a receipt portion 520. The ballot portion 510 and the receipt portion 520 may be separated from each other by tearing along a perforation 530. Once separated, the ballot portion 510 may be inserted into the ballot receptacle 435 of the ballot box 430 and the receipt portion 520 may be kept by a voter.

As further shown in FIG. 5, the ballot portion 510 includes a first section 540 that includes an election identifier (e.g., General Election 2004) and a unique ballot identifier (e.g., TOB AD 13 ED 45), which includes information such as, the town of the election (e.g., TOB), assembly district number (e.g., AD 13) and election district number (e.g., ED 45). The first section 540 also includes a transaction number (e.g., Transaction Number), which may be a non-sequential voter-specific number that includes information such as the date of the election and the election precinct number, and a bar code (e.g., Bar Code) that identifies the transaction number. As described, the transaction number may be a non-sequential number, for example, 041102/51344/059, where “041102” relates to the date of the election, “51344” relates to the election precinct and “059” is a voter-specific number that may be used to identify the voter.

The ballot portion 510 also includes a second section 550 that includes a list of the candidates or propositions selected by the voter. In other words, the second section 550 includes the voting selections made by the voter. This list of chosen candidates may be organized in rows and columns. A bar code associated with each candidate selected by the voter is included. The bar code is included for redundancy purposes and can be used in the event a candidate's name was not printed on the ballot 420. The bar codes may be read using a bar code scanner or a bar code wand that may be coupled, for example, to a USB port of the voting unit 120. It is to be understood that the information, for example, the election and unique ballot identifiers, on the ballot portion 510 may be locally programmable and configurable by election officials.

The receipt portion 520 is essentially a condensed version of the ballot portion 510. For example, it includes a first section 560 that corresponds to the first section 540 and a second section 570 that corresponds to the second section 550 except the second section 570 does not include the bar codes next to the voter's selections or the bar code that identifies the transaction number.

Referring back to FIG. 4, the ballot box 430 is used to store the ballot portion 510 of the ballot 420 after it is inserted through the ballot receptacle 435. The ballot box 430 may be integrated into the voting unit 120 or it may be removable. Moreover, the ballot box 430 may be located anywhere in the voting unit 120 or externally secured to the voting unit 120. If the ballot box 430 is integrated into the voting unit 120, it may have an opening (not shown) such that ballots can be removed therefrom by an election official having a key or a code that can be used to open the ballot box 430. Similarly, if the ballot box 430 is removable, it may be removed from an opening at the back or front of the voting unit 120. The ballot box 430 may also have an opening so that ballots can be removed without having to remove the ballot box 430 from the voting unit 120. In addition, the ballot box 430 may have a unique identifier located on it such as a bar code, infrared (IR) identifier, invisible ink or a numbered tag to prevent the ballot box 430 from being replaced with another ballot box after it is removed from the voting unit 120.

As further shown in FIG. 4, the keypad 425 is located at the front of the voting unit 120. The keypad 425 may be fixed to the voting unit 120, connected to the voting unit 120 with an extendable cord or by Velcro or located at another portion of the voting unit 120 such as the top of the printer tower 410 or in between the ballot box 430 and the display 405. The keypad 425 may be, for example, a push-button hand-held or non-hand-held input device or a push-button input device having raised keys with Braille thereon for enabling blind persons to vote.

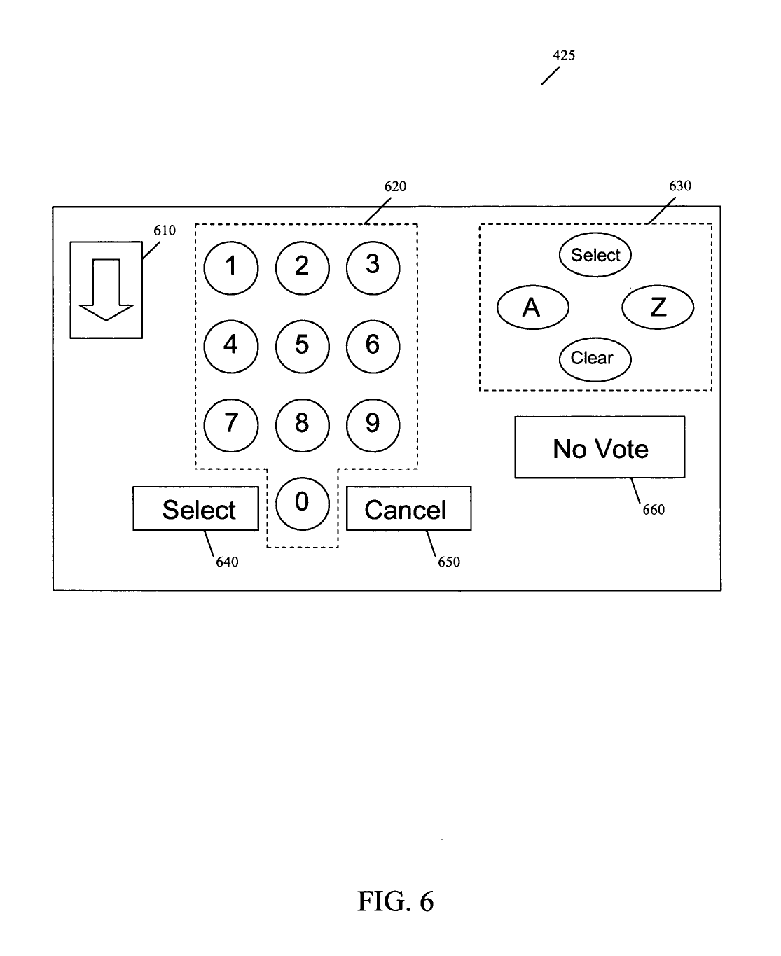

FIG. 6 illustrates an exemplary embodiment of the keypad 425. As shown in FIG. 6, the keypad 425 includes a number of buttons to facilitate the voting process. In particular, the keypad 425 includes a series of number buttons 620 for enabling the voter to enter a unique identifier associated with each candidate and write-in buttons 630 for allowing the voter to enter the name of a write-in candidate. The keypad 425 further includes a select button 640 and a cancel button 650 for allowing the voter to confirm their selections or cancel their selections, respectively, and a no vote button 660 for allowing the voter to confirm their desire not to vote for a certain office or proposition. The keypad 425 also includes a scroll bar or arrow 610 that may be used by a voter to review their voting selections after they have completed their initial voting selections.

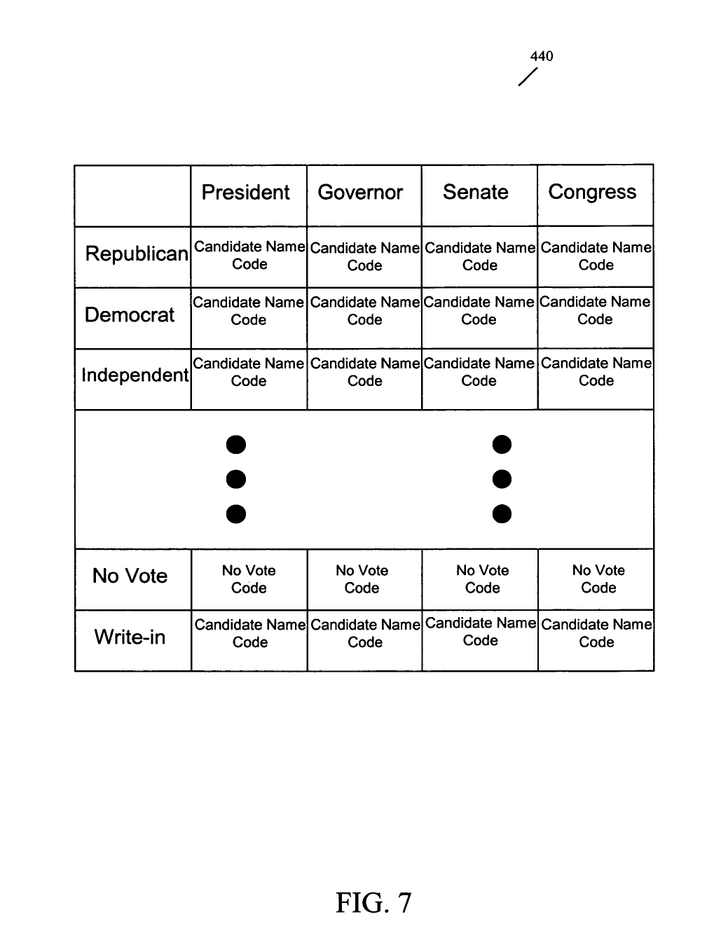

The voting unit 120 of FIG. 4 may also include a ballot template 440 attached to the front of the printer tower 410. The ballot template 440 is to be provided at each electronic voting system 100 such that a voter will have enough information to facilitate the voting process. As shown in FIG. 7, the ballot template 440 may include a number of rows and columns listing the candidates running for a particular office and their party affiliation. The ballot template 440 also includes a unique code listed next to or beneath each candidate's name that will be entered by the voter using the keypad 425 to indicate their candidate choice for a particular office. The unique code may be a four-digit code (e.g., 1001), where the first two digits (e.g., 10) represent a column on the ballot template 440 and the second two digits (e.g., 01) represent a potential selection in the column.

Although the ballot template 440 is shown attached to the front of the printer tower 410, it should be understood that the ballot template 440 could be located anywhere on the electronic voting system 100 such as on the face of the privacy screen 110, on top of the printer tower 410 or adjacent to either side of the display screen 405. The ballot template 440 may also be displayed in a display area of the display screen 405 or it may be projected from a fixed or portable laser projector 445 onto an area of the privacy screen 110 for viewing by a voter. In addition, the ballot template 440 may not be included with the electronic voting system 100. For example, the ballot template 440 may be handed to a voter as they enter a voting center or positioned or projected onto a wall of the voting center.

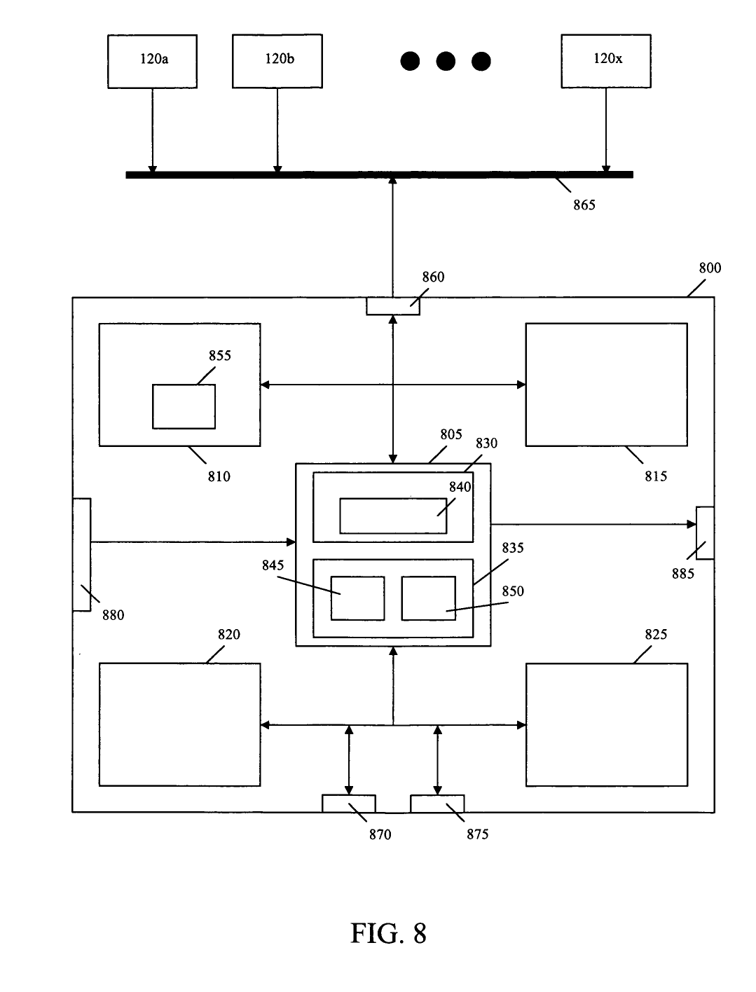

FIG. 8 is a block diagram of an exemplary embodiment of a voting unit 800. As shown in FIG. 8, the voting unit 800 includes a controller 805 connected to a printer 810, which includes a modular thermal printer 855, a display 815, a keypad 820 and an internal power source 825. The controller 805, which may be located on a single board computer such as a PC 104 card, is used to control the operation of the voting unit 800 and process voting information and includes a central processing unit (CPU) 830 and a memory 835. The CPU 830 includes a module 840 that includes one or more methods for electronic voting according to an exemplary embodiment of the present invention.

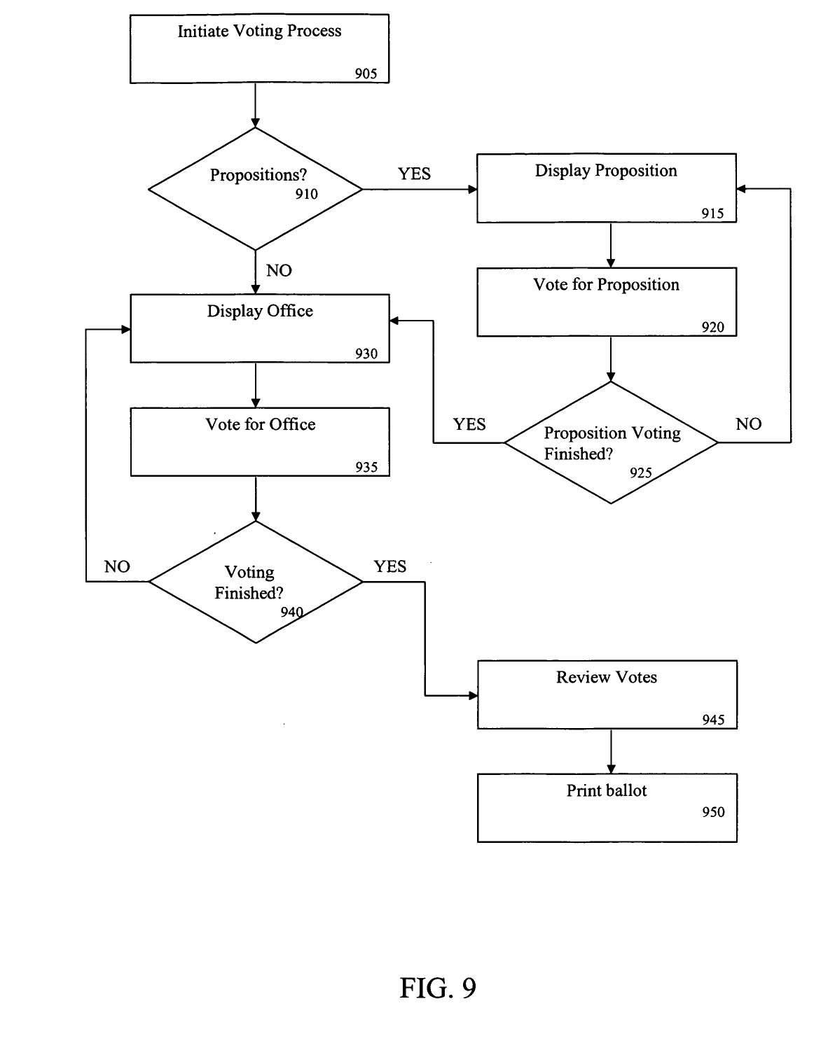

For example, the module 840 may include real-time operating software for implementing the methods to be discussed below with reference to FIG. 9. The software may be used to provide an audit trail of the voting activity and may output a report based on this activity using the printer 855. The software may also be used to demonstrate that at the opening time of the polling place there is a zero balance in the voting unit 800. In other words, the software will show that no votes have been received or tallied by the voting unit 800 prior to the set time for voting. In addition, the software may be configured to preclude “overvoting” and “undervoting”. With regard to “overvoting”, the software will be able to prevent two candidates from being voted for in the same column on the ballot template 440, except when permissible. Regarding “undervoting”, the software shall require that a voter select at least a no vote or a write-in candidate for a particular office or proposition.

The memory 835 includes a random access memory (RAM) 845 and a read only memory (ROM) 850. The memory 835 can also include a database, disk drive, tape drive, etc., or a combination thereof. The RAM 845 functions as a data memory that stores data used during execution of a program in the CPU 830 and is used as a work area. The ROM 850 functions as a program memory for storing a program executed in the CPU 830.

As further shown in FIG. 8, the voting unit 800 includes an external memory interface 880 coupled to the controller 805. The external memory interface 880 is, for example, a memory card interface for enabling the voting unit 800 to be upgraded with new functions or features or for enabling voting information to be removed from the voting unit 800. The voting unit 800 also includes additional external interfaces 860, 870 and 875 any of which could be a universal serial bus (USB), Ethernet, RJ-11, RJ-45, modem, FireWire, IR, radio frequency (RF) or Bluetooth type interfaces for receiving updated functions or features to be used by the voting unit 800 or for uploading voting information from the voting unit 800. The voting unit 800 may further include an external interface 885 for receiving a headphone jack.

By using the external interface 860, which in this example is a USB port, the voting unit 800 may be connected to a network of voting units 120a, b . . . x through an Ethernet cable 865. This network of voting units 800, 120a, b . . . x could be coupled to a host computer (not shown), which could be used to monitor the status of the voting units 800, 120a, b . . . x. The host computer could also be used to receive voting results from each of the voting units 800, 120a, b . . . x at the close of the official polling hour, thus providing another layer of redundancy to the voting process.

The power source 825 may be a battery such as a sealed liquid acid battery or an output or cable for connecting to an external power source. The power source 825 may also be a combination of the battery and an output or a cable for connecting to an external power source. In this configuration, the battery may be used as a back-up power source. Although not shown, the electronic voting unit 800 may also include a speaker and a headset such as a head mounted Sip/Puff switch for assisting a disabled voter. For example, by using audio directives the disabled voter may be navigated through the processes set forth below with reference to FIG. 9. They may then interact with the voting unit 800 and make their selection using the Sip/Puff switch. It is to be understood that the names of the candidates or descriptions of the propositions may be programmed or recorded into the voting unit 800 by local election officials by utilizing one of the external interfaces 860-880.

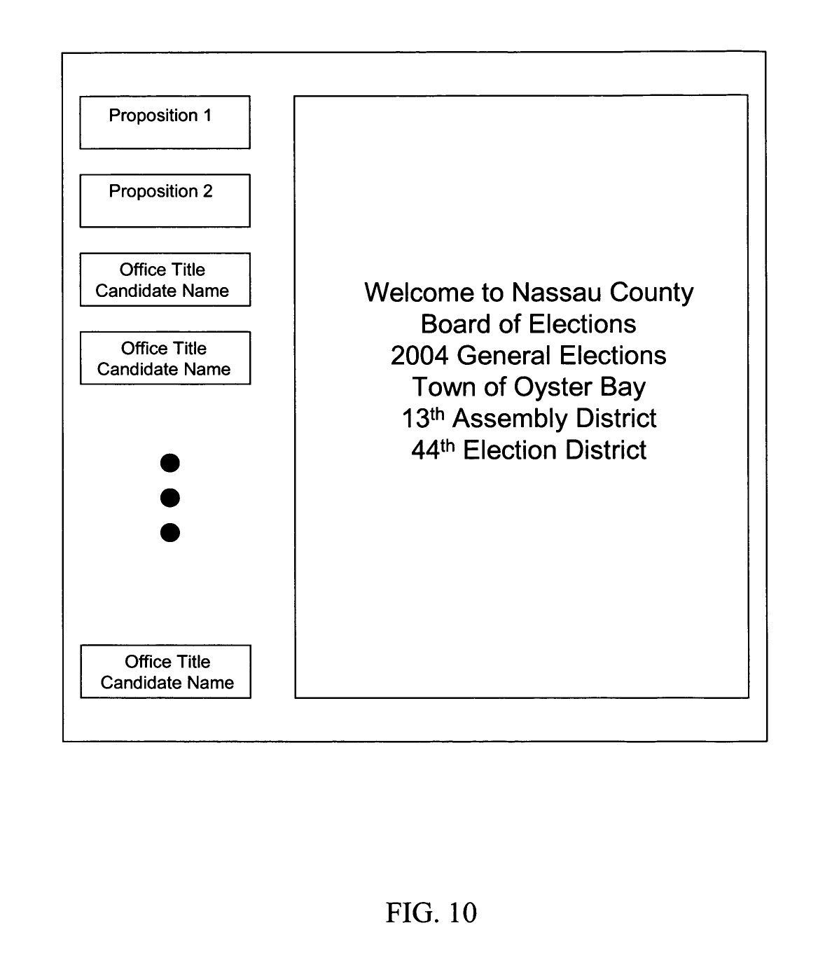

FIG. 9 is a flowchart illustrating a method for electronic voting according to an exemplary embodiment of the present invention. As shown in FIG. 9, after registering at a polling place on an election day and positioning themselves in front of the electronic voting system 100, the voting process is initiated for a voter (905). This is accomplished by presenting the voter with a welcome screen, which welcomes the voter and identifies the location of the precinct they are voting, as shown in FIG. 10. After welcoming the voter, the electronic voting system 100 provides a brief set of instructions regarding its use.

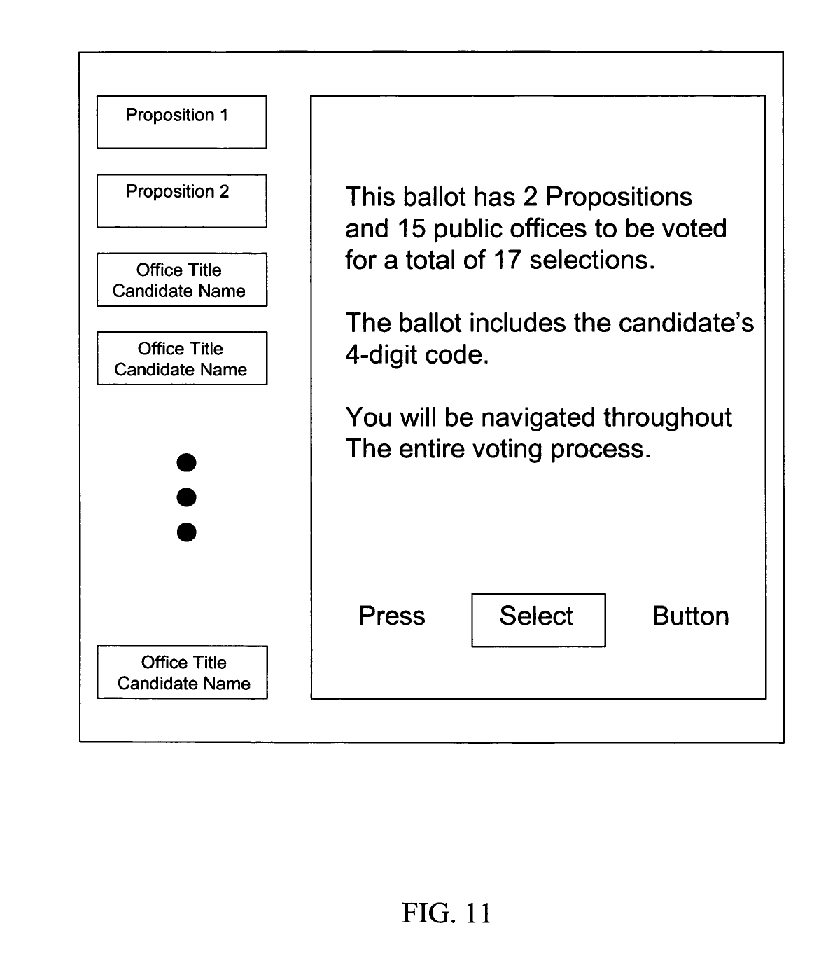

For example, the instructions may list the number of propositions to be voted for and the number of public offices to be voted for as shown in FIG. 11. The instructions may further include a description of the voting process regarding how the voter is to enter a candidate specific code, what to do in the event the code is improperly entered and how to designate a write-in candidate. In addition, the instructions may provide a description regarding how to review and change the selections made by the voter and finally how to complete the voting process. In order to navigate through the instructions, the voter moves to a subsequent screen, for example, by pressing the SELECT button 640 on the keypad 425. This is indicated to the voter on the display.

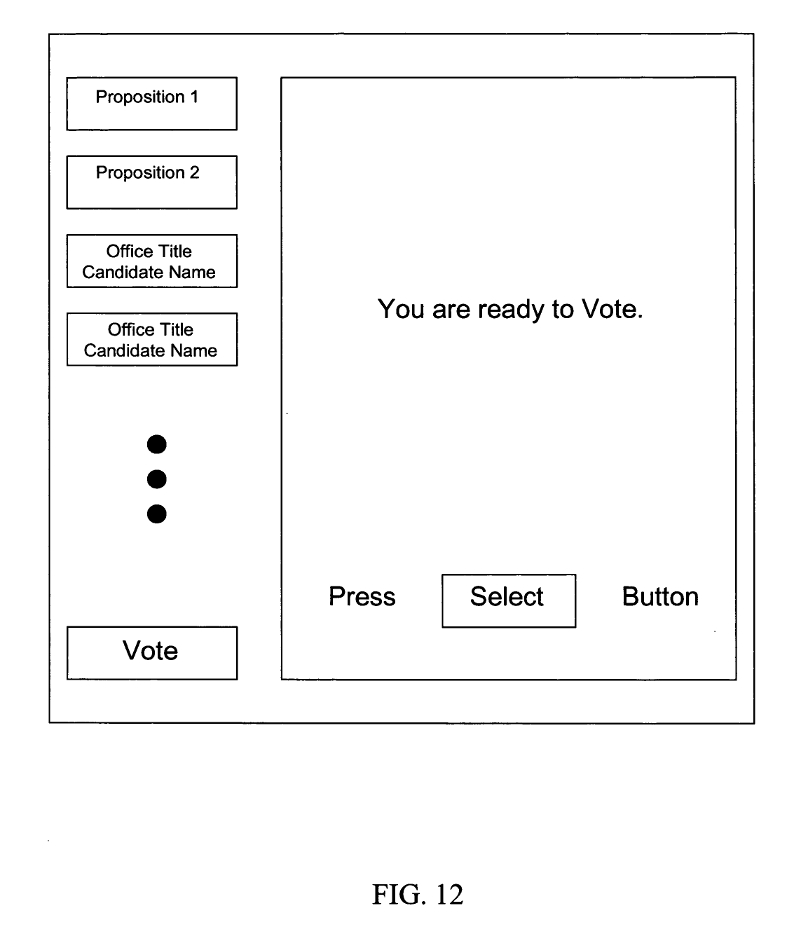

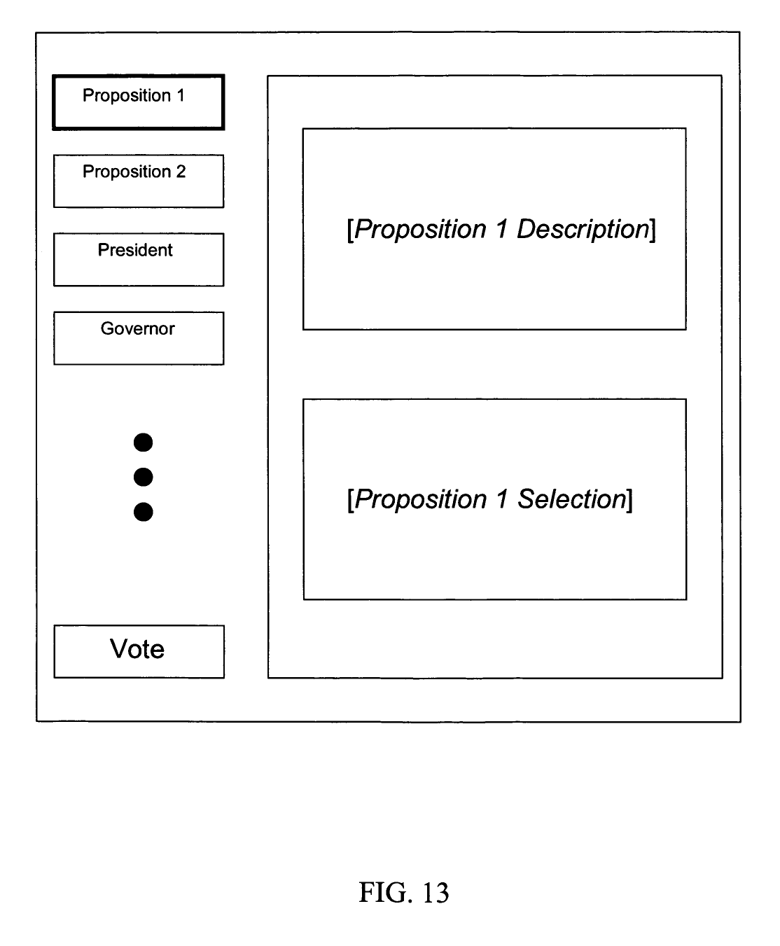

Once the voter has been welcomed and provided with the instructions they may begin to vote. This is accomplished by pressing the SELECT button 640 on the keypad 425 when prompted as shown in FIG. 12. After the SELECT button 640 has been pressed, a prompt may be displayed querying the voter if they wish to vote for any propositions (910). If the voter wishes to vote for a proposition or if there are any propositions to be voted for, a description of the first proposition to be voted for (e.g., Proposition 1 Description) is displayed to the voter on the right hand side of FIG. 13 (915). The voter then votes for the proposition (920). This is accomplished using the keypad 425.

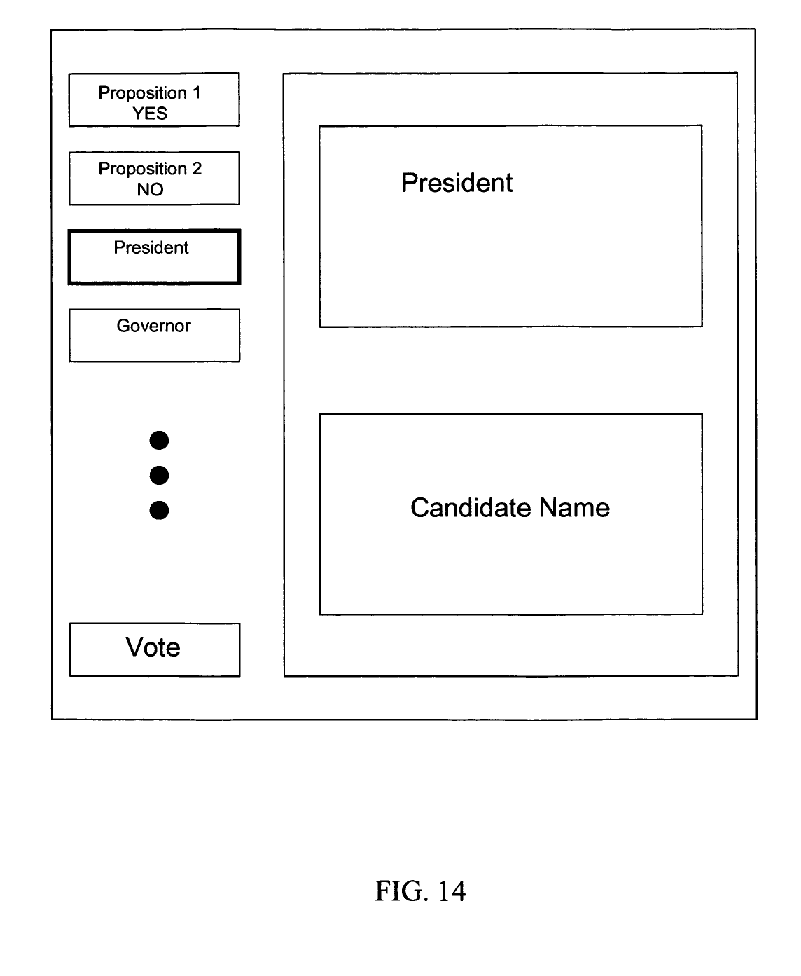

For example, the voter selects whether to vote “Yes” or “No” for the proposition by entering a code provided on the ballot template 440 associated with a “Yes” or a “No” for the selected proposition. When entering the code, the code may be displayed on a bottom box (e.g., Proposition 1 Selection) of the screen. After the code associated with “Yes” or “No” is selected and the select button 640 is pressed, the voter will see their choice illustrated in the upper left hand corner of the screen in the “Proposition 1” box as shown in FIG. 14. It is to be understood that if the voter initially enters the wrong code for either the proposition or the candidate, they can correct their initial selection by pressing the cancel button 650. The voter will also be provided with another opportunity to change their initial selection during step 945, which will be discussed in detail hereinafter.

It should be understood that if the voter enters an invalid code, an error message would appear such as “invalid code please re-select”, and the voter will re-vote by pressing the CANCEL button 650 on the keypad 425 and enter a valid code. In addition, if a code is entered with the wrong first two digits, the screen may flash indicating to the voter that they are entering an invalid code even if it is valid for another proposition or candidate.

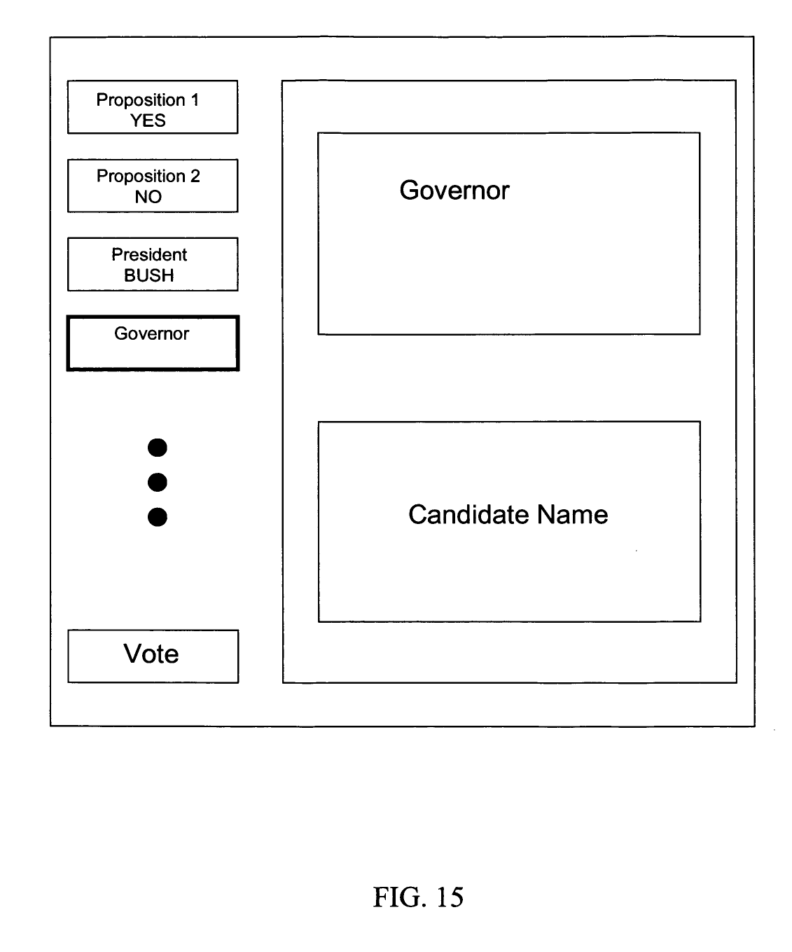

If there are more propositions to be voted for (925), steps 915 and 920 may be repeated and a second proposition is presented to the voter who may then vote for the second proposition. If, however, there are no more propositions to be voted for (925), the voter proceeds to vote for an office such as President, Governor or Senator. At this point, the first office to be voted for is presented to the voter (930). This is illustrated on the right hand side of FIG. 14. In particular, the voter may now vote for the office of President. The voter then votes for the office of President by entering a code on the keypad 425 that is associated with the candidate they desire to be President (935). The voter's choice is then highlighted on the left hand side of the screen as shown in FIG. 15.

During the voting process, if a voter decides not to vote for a particular office, they may select the NO VOTE button 660 on the keypad 425. In addition, if the voter decides to vote for a write-in candidate, the voter shall enter the appropriate write-in code from the ballot template 440. This will cause voting unit 800 to request the voter to enter the name of the write-in candidate. The write-in candidate's name may be entered using the write-in buttons 630. Once the write-in candidate's name is entered, the voter presses the select button 640 and the write-in candidate's name is then displayed on the left hand side of the screen.

If the voting is not finished (940), for example, there are more offices to vote for, steps 930 and 935 are repeated for the remaining offices. If, however, the voting is finished, the voter will be prompted to review their choices (945). At this time, the left hand column of the screen will be highlighted and the voter may reconsider the selections they have made. The voter may scroll down the left hand column using the arrow key 610 of the keypad 425. If the voter desires to change a selection, they may press the SELECT button 640 on the keypad 425 and change their vote.

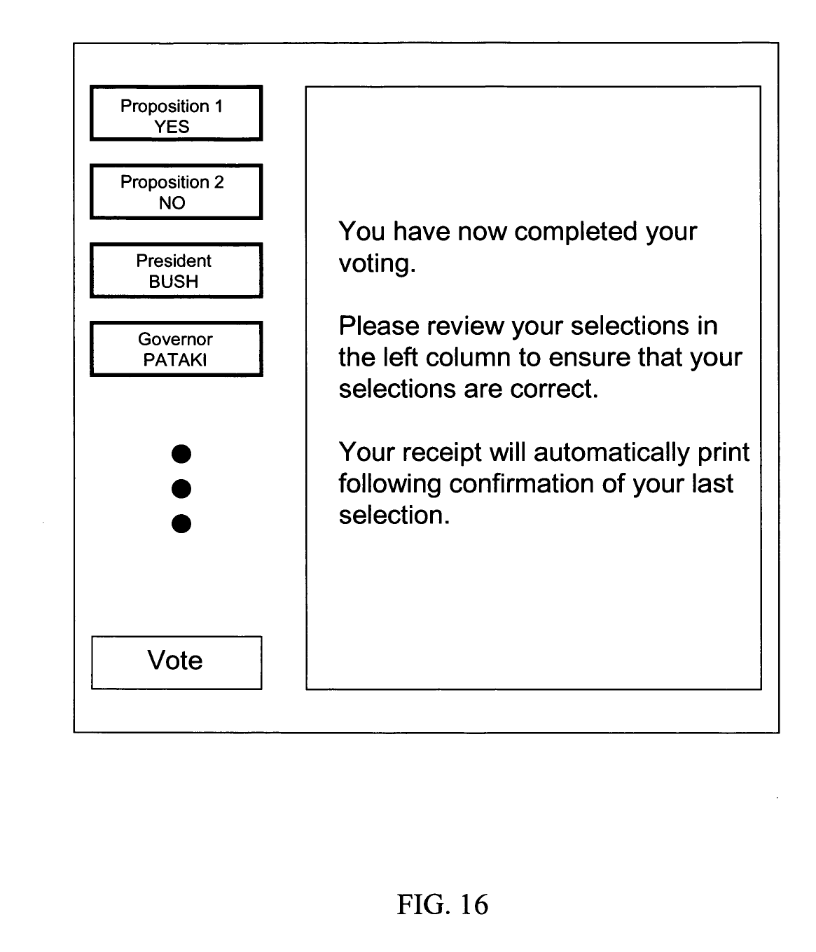

Upon completing this process, the real-time software used by the module 840 intuitively selects the VOTE icon shown in FIG. 16 and the ballot 420 indicating the voter's choices is printed (950). This may also be done by the voter. The software is able to select the VOTE icon because upon confirmation of the voter's review of their choices, the software knows the VOTE icon is next. Thus, as the voter confirms their last vote, the vote selection will automatically occur and begin to print the ballot 420. This occurs automatically as the voter may or may not know they are finished and they may stand there waiting for something to happen, thus extending the time the voter is in the voting area thereby delaying other voters. The ballot 420 is then removed from the voting unit 800, the voter separates the ballot portion 510 from the receipt portion 520 and inserts the ballot portion 510 into the ballot box 430, thus completing the voting process.

In accordance with an exemplary embodiment of the present invention, a voter can easily make or change their voting selections and have confidence in their privacy while doing so. In addition, the configuration of the electronic voting system enables election administrators to easily transport, install and monitor the system. Moreover, the ballot, receipt and memory devices of the present invention provide multiple layer of redundancy, while the ballot, which is also electronically re-configurable, provides election officials with real-time control over last minute election changes, the ability to correct erroneously configured ballots or to customize the ballots for local district's needs or desires.

It is to be further understood that because some of the constituent system components and method steps depicted in the accompanying figures may be implemented in software, the actual connections between the system components (or the process steps) may differ depending on the manner in which the present invention is programmed. Given the teachings of the present invention provided herein, one of ordinary skill in the art will be able to contemplate these and similar implementations or configurations of the present invention.

It should also be understood that the above description is only representative of illustrative embodiments. For the convenience of the reader, the above description has focused on a representative sample of possible embodiments, a sample that is illustrative of the principles of the invention. The description has not attempted to exhaustively enumerate all possible variations. That alternative embodiments may not have been presented for a specific portion of the invention, or that further undescribed alternatives may be available for a portion, is not to be considered a disclaimer of those alternate embodiments. Other applications and embodiments can be implemented without departing from the spirit and scope of the present invention.

It is therefore intended, that the invention not be limited to the specifically described embodiments, because numerous permutations and combinations of the above and implementations involving non-inventive substitutions for the above can be created, but the invention is to be defined in accordance with the claims that follow. It can be appreciated that many of those undescribed embodiments are within the literal scope of the following claims, and that others are equivalent.

What is claimed is:

1. An electronic voting device, comprising:
a processor for processing voting information;
a display for displaying the voting information and a voting selection;
an input for receiving the voting selection;
a printer for printing a ballot having a ballot portion and a receipt portion, wherein the ballot portion and the receipt portion comprise the voting selection; and
a ballot box for receiving the ballot portion.

2. The device of claim 1, wherein the processor comprises:
a memory for storing the voting information and a voting record associated with the voting selection.

3. The device of claim 1, wherein the display is one of a cathode ray tube (CRT) display, a liquid crystal display (LCD), and a plasma display.

4. The device of claim 1, wherein the display is one of a touch-type display and a rotatable display.

5. The device of claim 1, wherein the input is a keypad.

6. The device of claim 5, wherein the keypad includes raised keys with Braille.

7. The device of claim 1, wherein the printer is one of a modular thermal printer, a dot-matrix printer, and an impact-type printer.

8. The device of claim 1, wherein the ballot box comprises:
a tamper-proof ballot receptacle.

9. The device of claim 1, further comprising:
an external memory interface for receiving updated voting information.

10. The device of claim 1, further comprising:
an input/output (I/O) interface for performing one of receiving updated voting information and uploading the voting selection to an external device.

11. The device of claim 1, further comprising:
a power source.

12. The device of claim 11, wherein the power source in an internal battery.

13. The device of claim 1, wherein the ballot portion of the ballot comprises:
a first portion comprising: an election identifier; a ballot identifier; a transaction number; and a bar code identifier; and
a second portion comprising: a first listing of the voting selection and an associated bar code identifier, the receipt portion of the ballot comprises:
a first portion comprising: the election identifier; the ballot identifier; and the transaction number; and
a second portion comprising: a second listing of the voting selection.

14. An electronic voting system, comprising:
a voting device comprising: a processor for processing voting information; a display for displaying the voting information and a voting selection; an input for receiving the voting selection; a printer for printing a ballot having a ballot portion and a receipt portion; and a ballot box for receiving the ballot portion;
a privacy screen for impeding unauthorized viewing of the voting device from side perspectives during voting; and
a pedestal for performing one of placing the voting device in a voting configuration and in a transportation configuration.

15. The voting system of claim 14, wherein the privacy screen is connected along a left and right side and back of the electronic voting device.

16. The voting system of claim 14, wherein the pedestal is connected to a bottom of the voting device when in the voting configuration and to a top of the voting device when in a transportation configuration.

17. A ballot, comprising:
a ballot portion comprising: a first portion comprising: an election identifier; a ballot identifier; a transaction number; and a bar code identifier; and a second portion comprising: a first listing of a voting selection and a bar code identifier associated with the voting selection; and
a receipt portion comprising: a first portion comprising: the election identifier; the ballot identifier; and the transaction number; and a second portion comprising: a second listing of the voting selection.

18. The ballot of claim 17, wherein the election identifier identifies an election, the ballot identifier identifies an area of the election and an election district number, the transaction number identifies a date of the election and the election district number, and the bar code identifier includes the information of the transaction number.

19. A method for electronic voting, comprising:
providing voting instructions;
receiving an instruction to proceed with voting;
displaying one of a proposition and an office to be voted for;
receiving a voting selection in response to one of the proposition and the office to be voted for;
providing a review screen comprising the voting selection;
determining the voting is complete; and
printing a ballot comprising a ballot portion and a receipt portion, wherein the ballot portion and the receipt portion comprise the voting selection.

20. The method of claim 19, further comprising:
receiving the ballot portion.
